(19) United States
(12) Patent Application Publication
(10) Pub. No.: US 2007/0275249 A1
(43) Pub. Date: Nov. 29, 2007

(54) SUBSTRATE FOR FLEXIBLE DISPLAY DEVICES

(76) Inventors: Syh-Tau Yeh, Taoyuan County (TW); Yao-Ming Chen, Taoyuan County (TW)

Correspondence Address: NORTH AMERICA INTELLECTUAL PROPERTY CORPORATION, P.O. BOX 506, MERRIFIELD, VA, 22116, US

(21) Appl. No.: 11/428,550

(22) Filed: Jul. 4, 2006

Related U.S. Application Data
(63) Continuation-in-part of application No. 11/420,012, filed on May 24, 2006.

(51) Int. Cl. B32B 27/38; B32B 27/30

(52) U.S. Cl. 428/416; 428/413; 428/521; 428/522; 525/529

(57) ABSTRACT

A flexible substrate with electromagnetic shielding (EMS) function is provided. This substrate comprises a conductive backing film; and a thermosetting resin layer coated on the conductive backing film. The conductive backing film comprises aluminum foil. The thermosetting resin layer comprises modified carboxylated NBR, dimer acid-modified thermosetting epoxy resins and heat-resistive acrylic resins. This type of substrate can be used for electromagnetic shielding purpose. The flexible substrate can be used in various electronic applications, for example, flexible display applications.

### CROSS REFERENCE TO RELATED APPLICATIONS

This is a continuation-in-part of U.S. patent application Ser. No. 11/420,012 filed May 24, 2006.

### BACKGROUND OF THE INVENTION

1. Field of the Invention

The present invention relates to a flexible substrate with electromagnetic shielding (EMS) capability and high dimensional stability. The flexible substrate of this invention has high tack, excellent adhesion, heat resistance, and flexibility, which is particularly suited for applications in high temperature environments. The flexible substrate of this invention is also suited for flexible display applications.

2. Description of the Prior Art

Our daily live is filled with wireless-communication such as cellular phones and High-Speed-Wire-Less LAN. To prevent malfunctioning of electronic appliances caused by electromagnetic wave and to prevent inferiority of communication, electromagnetic shielding (EMS) technology is becoming more and more important. One conventional method of electromagnetic shielding is attaching an electromagnetic shield sheet to the electronic components, by using electric conductive bonding agent.

For example, U.S. Pat. No. 4,777,205 filed Jul. 22, 1987 to La Scola et al. teaches an electrically conductive organopolysiloxane composition containing (1) an organopolysiloxane capable of being crosslinked, (2) a crosslinking agent capable of reacting with the organopolysiloxane, (3) from 120 to 200 parts by weight of silver coated mica particles per 100 parts by weight of organopolysiloxane (1) in which the silver coated mica particles contain from 50 to 80 percent by weight of silver based on the weight of the mica and (4) sufficient carbon black to stabilize the composition.

U.S. Pat. No. 5,366,664 filed May 4, 1992 to Varadan et al. discloses a conductive electromagnetic shielding (EMS) composition based on a mixture of a polymeric or liquid matrix material and a synergestic combination of conductive powders, fibers and optional flake components.

U.S. Pat. No. 6,501,016 filed May 2, 2000 to Sosnowski teaches an electromagnetic shielding system for a printed circuit board (PCB) comprising shielding enclosure having a plurality of sidewalls and an integral top surface. The top surface includes a scored line for allowing removal of an interior portion of the top surface to thereby define a remaining perimeter rim, and a replacement cover for attachment to the remaining cover rim.

U.S. Pat. No. 6,706,964 filed Aug. 23, 2002 to Igarashi et al. teaches a method for shielding printed circuit board. This patent discloses an electronic device having a printed circuit board having a ground, an electrically insulating layer provided on a face of the printed circuit board, and an electromagnetic shielding layer adhered to the face of the printed circuit board through the electrically insulating layer. The ground of the printed circuit board and the electromagnetic shielding layer are conducted electrically.

In some fields of electronic industry, it is often desired to provide a handier and cost-effective electromagnetic shielding system or method in order to cope with various requirements for the manufacturing of electronic products. The conventional shielding techniques focus on the use of standard metals and their composites, which have disadvantage due to limited mechanical flexibility, heavy weight, corrosion, and difficulty of tuning the shielding efficiency. It is disadvantageous to use conductive silver glue, which is typically coated on flexible PCBs, because it is expensive, not easy to apply by screen-printing methods, and has poor resistance to heat.

Another approach to electromagnetic shielding is using an aluminum foil coated with a pressure-sensitive adhesive. However, such pressure-sensitive adhesive, which is typically a non-permanent bonding, silicone-based agent, has poor heat resistance. In some high temperature circumstances such as soldering operation or burn-in thermal cycle in the manufacturing processes of PCBs, the aluminum foil attached to the PCB peels off because of melting of the pressure-sensitive adhesive layer, which loses its adhesive ability during such high temperature operation.

In light of the above, there is a need in this industry to provide an electromagnetic shielding tape that is improved in terms of cost, ease of use as well as heat resistance.

### SUMMARY OF THE INVENTION

It is one object of the present invention to provide an improved electromagnetic shielding (EMS) tape or substrate with high tack, excellent adhesion, heat resistance, and flexibility, which is particularly suited for applications in high temperature environments.

According to the claimed invention, an electromagnetic shielding (EMS) tape is provided. The EMS tape comprises a conductive backing film; and a thermosetting resin layer coated on the conductive backing film. The conductive backing film comprises aluminum foil. The thermosetting resin layer comprises modified carboxylated NBR, dimer acid-modified thermosetting epoxy resins and heat-resistive acrylic resins.

The thermosetting resin layer comprises additive resins selected from the group consisting of Bisphenol-A epoxy resins, Brominated Bisphenol-A epoxy resins, Bisphenol-F epoxy resins, long-chain Bisphenol-A epoxy resins, long-chain Bisphenol-F epoxy resins, CTBN modified epoxy resins, carboxylated acrylonitrile-butadiene rubber, and carboxylated acrylic rubber.

The thermosetting resin layer further comprises a hardening agent including dicyandiamide, imidazoles, Diamino diphenyl sulfone (DDS) and BF₃-MEA, and catalyst.

The thermosetting resin layer further comprises at least one of the following agents: rheological agents, thixotropic reagent, fumed silica, defoamers, leveling agents, pigments, fire retardants and inorganic fillers.

From one aspect of this invention, a substrate suited for flexible display devices is provided. The substrate comprises a conductive backing film having a first side and a second side; a first fully cured C-stage thermosetting resin layer coated on the first side of the conductive backing film; and a second fully cured C-stage thermosetting resin layer coated on the second side of the conductive backing film.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings:

FIG. 1 is a sectional view of the laminated, single-sided EMS tape prepared according to the first preferred embodiment of the present invention;

FIG. 2 is a sectional view of the laminated, single-sided EMS tape prepared according to the second preferred embodiment of the present invention;

FIG. 3 is a sectional view of the laminated, two-sided EMS tape prepared according to the third preferred embodiment of the present invention;

FIG. 4 is a sectional view of the laminated, two-sided EMS tape prepared according to the fourth preferred embodiment of the present invention;

FIG. 5 is a sectional view of the laminated, two-sided EMS tape prepared according to the fifth preferred embodiment of the present invention;

FIG. 6 is a sectional view of the laminated, two-sided EMS tape prepared according to the sixth preferred embodiment of the present invention;

FIG. 7 is a sectional view of the laminated, two-sided EMS substrate prepared according to the seventh preferred embodiment of the present invention;

FIG. 8 lists the possible products corresponding to the embodiments described herein and applications thereof;

FIG. 9 lists the experiment results based on dimmer acid modified epoxy resin having different compositions; and

FIG. 10 lists the experiment results based on modified carboxylated NBR having different compositions.

### DETAILED DESCRIPTION

The present invention pertains to an improved electromagnetic shielding (EMS) tape or electromagnetic interference (EMI) shielding tape (hereinafter collectively referred to as EMS tape) with excellent adhesion, heat resistance, and flexibility.

The EMS tape according to this invention is appropriate for use in printed circuit boards, cellular phones, computers and computer peripherals, ground stations, PDAs, disk drives, medical equipments, modems and automotive electronics, etc. The present invention EMS or EMI shielding tape is also ideal for applications such as cable and cable assembly shielding for satellites, electric vehicles, and robotics.

Other industrial and domestic uses of the subject matter of the invention will also be evident to those skilled in the art. For example, the present invention EMS tape may be used to facilitate heat conduction and for various anti-static electricity applications.

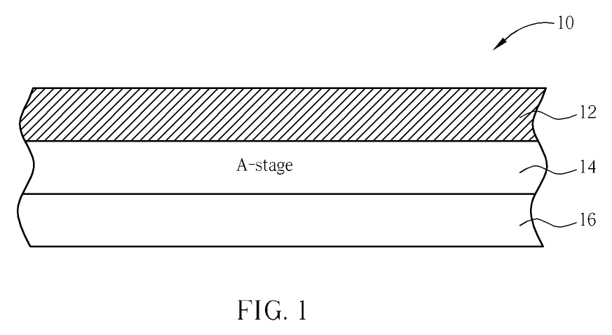

FIG. 1 is a sectional view of the laminated, single-sided EMS tape 10 prepared according to the first preferred embodiment of the present invention. As shown in FIG. 1, the laminated EMS tape 10 comprises a conductive backing film 12, a flexible thermosetting resin coating 14 coated on one side of the conductive backing film 12 and a release layer 16 disposed on the thermosetting resin coating 14. According to the first preferred embodiment of the present invention, the conductive backing film 12 is preferably an aluminum foil. However, any other suitable metal foil or cloth may be employed.

The thermosetting resin coating 14 contains a resin, which polymerizes to a permanently solid and infusible state and forms a permanent bonding interface upon the application of heat. According to the first preferred embodiment, the thermosetting resin coating 14 is preferably formed of thermosetting epoxy resin composition such as modified carboxylated NBR (modified XNBR; wherein NBR is the abbr. of acrylonitrile butadiene rubber), dimer acid-modified thermosetting epoxy resins or heat-resistive acrylic resins, and more preferably, dimer acid modified thermosetting epoxy resins.

Exemplary dimer acid modified thermosetting epoxy resins include but not limited to NPER-172 (Dimer Acid modified DGEBA) available from Nanya Plastics Corp. (NPER-172 is a product name of Nanya Plastics Corp.), HyPox DA323 (Dimer Acid Adducted to an Epoxidized Bisphenol A Resin; CAS No. 67989-52-0) available from CVC Specialty Chemicals Inc., and ERYSYS GS-120 (Dimer Acid Glycidyl Ester; CAS No. 68475-94-5) available from CVC Specialty Chemicals Inc.

In order to adjust the reactivity and/or physical properties, the aforesaid resins may be employed singly or combined with other types of additive resins. For example, the aforesaid other types of additive resins may be selected from the group consisting of Bisphenol-A epoxy resins, Brominated Bisphenol-A epoxy resins, Bisphenol-F epoxy resins, long-chain Bisphenol-A epoxy resins, long-chain Bisphenol-F epoxy resins, CTBN modified epoxy resins, carboxylated acrylonitrile-butadiene rubber, and carboxylated acrylic rubber.

To obtain adequate softness, the content of the dimer acid modified thermosetting epoxy resin preferably ranges between 40-100 phr (pars per hundred parts) of total weight of the resin mixture, while the aforesaid additive resin preferably ranges between 60-0 phr of total weight of the resin mixture.

The aforesaid resins may be mixed with proper amount of hardening agent and catalysts. For example, the hardening agent may include dicyandiamide, imidazoles or diamino-diphenyl sulfone (DDS), preferably, dicyandiamide and imidazoles. Assuming that the total weight of the prepared starting resin mixture is 100 phr, the content of dicyandiamide or imidazoles preferably ranges between 0-10 phr. According to this invention, the aforesaid catalyst may be amines, imidazoles, or BF3-MEA ranging between 0.1-10.0 phr.

Furthermore, depending on the requirements and purposes of use, other additives such as rheological agents, thixotropic reagent, fumed silica, defoamers, leveling agents, organic solvents, pigments, fire retardants and inorganic fillers may be added.

The aforesaid modified carboxylated NBR mixed with proper amount of epoxy resin may be employed to form a flexible thermosetting resin system, which is suited for applications as a bonding agent between a flexible PCB and its protection film or coverlay. The aforesaid flexible thermosetting resin system is typically based on a general type epoxy resin such as Bisphenol-A epoxy resins, Brominated Bisphenol-A epoxy resins, Bisphenol-F epoxy resins, long-chain Bisphenol-A epoxy resins, long-chain Bisphenol-F epoxy resins. Nevertheless, in order to increase the softness of the thermosetting resin coating 14, a larger amount of the aforesaid modified carboxylated NBR is added. Assuming that the total weight of the prepared starting epoxy resin is 100 phr, the content of aforesaid modified carboxylated NBR preferably ranges between 30-100 phr.

The thermosetting resin coating 14 may be thermally processed to reach A-stage, B-stage or C-stage. According to the first preferred embodiment, the thermosetting resin coating 14 is in A-stage. At room temperature, the A-stage thermosetting resin coating 14 acts substantially as ordinary pressure-sensitive adhesives and is capable of adhering the conductive backing film 12 to a surface of an object such as a PCB or a cellular phone. As the temperature rises, crosslinking reaction occurs in the A-stage thermosetting resin coating 14 and gradually transforms itself to B-stage (partially cured) and then C-stage (fully cured), thereby forming a heat resistant permanent bonding interface between the conductive backing film 12 and the attached object. The major difference between the conventional pressure-sensitive adhesives and the A-stage thermosetting resin coating 14 is that the conventional pressure-sensitive adhesives soften and eventually peel off from the attached object when the temperature rises.

To reach the A-stage, the thermosetting resin coating 14 containing the above-described resin composition is baked to an extent that the solvent is substantially completely removed, thereby forming a dry and tacky film. At this phase, no crosslinking reaction occurs in the baked thermosetting resin coating 14, that is, the crosslinking density at his phase is substantially zero. For example, the thermosetting resin coating 14 is baked at a relatively lower temperature such as 90° C. for a time period of about 5 minutes to reach the A-stage.

The A-stage thermosetting resin coating 14 may be further thermally processed to induce crosslinking reaction therein and convert itself into the B-stage. It is advantageous to use the B-stage thermosetting resin coating in some particular circumstances because the B-stage thermosetting resin coating is tack-free at room temperature (˜25° C.) while its tack increases as the B-stage thermosetting resin coating is further thermally treated at high temperatures. For example, the B-stage thermosetting resin coating may be used in the attachment or lamination of the coverlay to the flexible PCB or in the attachment of the prepreg to the hard board PCB. In both examples, the coverlay or prepreg can move freely over the flexible PCB or hard board PCB at room temperatures, and after the coverlay or prepreg aligns with the flexible PCB or hard board PCB, a thermal pressing process is then carried out to cure the B-stage thermosetting resin coating 14 in place, thereby completing the attachment.

To reach the B-stage, the A-stage thermosetting resin coating 14 may be cured at a relatively higher temperature of about 150° C. for a time period of about 3-5 minutes. It is understood that the aforesaid processing conditions are merely for illustration purposes. In practical use, the baking conditions may be adjusted according to the content of hardening agent or catalyst in the recipe of the starting resin system.

The B-stage thermosetting resin coating may be further cured and converted to the C-stage. The C-stage thermosetting resin coating is fully cured and hardened resin, which has superior heat resistance, chemical resistance, and good adhesion. The C-stage thermosetting resin coating shows good flexibility and can function as a good protection film of metal foils. To reach the C-stage, the B-stage thermosetting resin coating may be cured at a relatively higher temperature of about 150° C. for a time period of about 10 minutes. It is understood that the aforesaid processing conditions are merely for illustration purposes. In practical use, the baking conditions may be adjusted according to the content of hardening agent or catalyst in the recipe of the starting resin system.

The definition of the A-, B-, and C-stage thermosetting resin may be summarized as follows:

A-Stage: Uncured resin. Solvent is removed from the starting resin mixture but the resin is not cured. The crosslinking density at his phase is substantially zero. The A-stage thermosetting resin coating 14 is dry but shows tack. Acting as pressure-sensitive adhesives at room temperature.

B-Stage: Partially cured resin. The A-stage resin is partially cured and baked to induce crosslinking reaction and then cooled down before it is fully cured. The B-stage resin is tack-free at room temperature but is becomes tacky when the temperature rises.

C-Stage: Fully cured resin. The B-stage resin is converted to C-stage when heated and cannot be remolded. The C-stage resin is flexible and has good heat resistance and chemical resistance. The C-stage resin may be used as a protection film or an insulating film adhered to an aluminum foil. The C-stage resin may be used as a permanent bonding interface between an aluminum foil and an attached object.

The present invention EMS tapes utilizing flexible thermosetting epoxy resins are promising materials for shielding electromagnetic radiation and reducing or elimination of electromagnetic interference (EMI) because of their relatively high flexibility, heat resistance and ease of control of physical/chemical properties through chemical processing. The crosslinking density of the thermosetting resin may be adjusted by controlling the baking temperature and baking time. The crosslinking density affects the tack of the resin.

The thermosetting resin coating 14 at different stages may be coated on one side or two sides of the conductive backing film 12, thus generating a variety of composite film products and combinations, which are suited for EMI shielding, thermal conduction, or anti-static electricity applications, and meet different requirements of different situations.

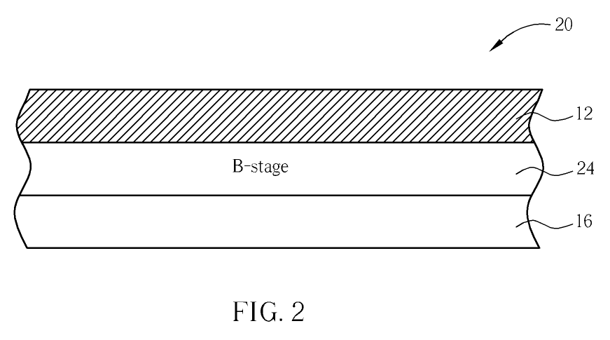

FIG. 2 is a sectional view of the laminated, single-sided EMS tape 20 prepared according to the second preferred embodiment of the present invention. As shown in FIG. 2, the laminated EMS tape 20 comprises a conductive backing film 12, a partially-cured B-stage thermosetting resin coating 24 coated on one side of the conductive backing film 12, and a release layer 16 disposed on the thermosetting resin coating 14. The conductive backing film 12 is preferably an aluminum foil. As previously mentioned, the B-stage thermosetting resin coating 24 is tack-free at room temperature, and can be heated to form a permanent bonding interface. Such EMS tapes are suited for lamination process involving pre-alignment. For example, the B-stage thermosetting resin coating 24 may be used in the attachment process or lamination of the coverlay to the flexible PCB or in the attachment process of the prepreg to the hard board PCB. In both examples, the coverlay or prepreg can move freely over the flexible PCB or hard board PCB at room temperatures, and after the coverlay or prepreg aligns with the flexible PCB or hard board PCB, a thermal pressing process is then carried out to cure the B-stage thermosetting resin coating 24 in place, thereby completing the attachment.

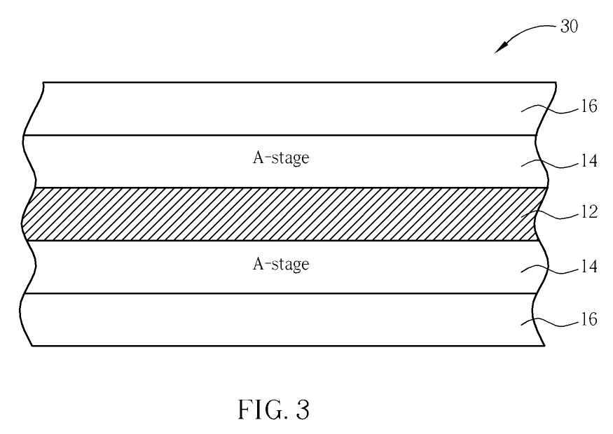

FIG. 3 is a sectional view of the laminated, two-sided EMS tape 30 prepared according to the third preferred embodiment of the present invention. As shown in FIG. 3, the laminated EMS tape 30 comprises a conductive backing film 12. A-stage thermosetting resin coatings 14 are coated on both sides of the conductive backing film 12, and a release layer 16 disposed on each thermosetting resin coating 14. The EMS tape 30 has two sides coated with A-stage thermosetting resin coatings 14 that is tacky and can be used as double-side adhesive. The EMS tape 30 overcomes the disadvantages of conventional double-side pressure-sensitive adhesive and has improved heat resistance and chemical resistance. The A-stage thermosetting resin coatings 14 can be heated and fully cured to form permanent and flexible bonging interface.

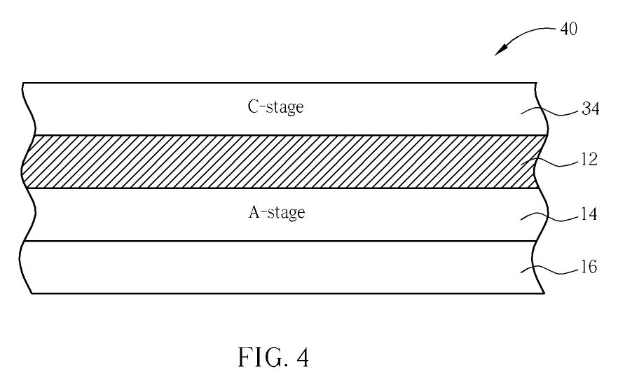

FIG. 4 is a sectional view of the laminated, two-sided EMS tape 40 prepared according to the fourth preferred embodiment of the present invention. As shown in FIG. 4, the laminated EMS tape 40 comprises a conductive backing film 12 such as aluminum foil. A-stage thermosetting resin coating 14 is coated on one side of the conductive backing film 12. C-stage thermosetting resin coating 34 is coated on the other side of the conductive backing film 12. A release layer 16 is disposed on the A-stage thermosetting resin coating 14.

By way of example, the EMS tape 40 can be manufactured by coating a layer of starting thermosetting resin system on one side of the conductive backing film 12, backing and fully curing the layer of starting thermosetting resin system to C-stage, thereby forming an insulating protection film. After this, another layer of starting thermosetting resin system is coated on the other side of the conductive backing film 12 and is baked to remove solvent (uncured) to form the tacky A-stage thermosetting resin coating 14. The EMS tape 40 has good solder resistance and good insulation property. The EMS tape 40 can be used to replace silver glue in the manufacturing process of flexible PCB. The advantages at least include ease of use and low cost.

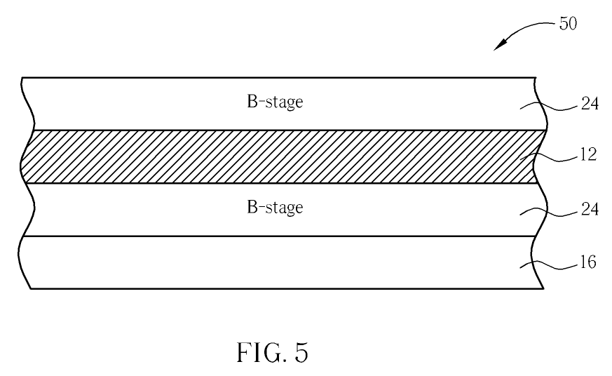

FIG. 5 is a sectional view of the laminated, two-sided EMS tape 50 prepared according to the fifth preferred embodiment of the present invention. As shown in FIG. 5, the laminated EMS tape 50 comprises a conductive backing film 12 such as aluminum foil. B-stage thermosetting resin coatings 24 are coated on both sides of the conductive backing film 12. A release layer 16 is disposed on one of the B-stage thermosetting resin coating 24. The EMS tape 50 is a thermo-pressing EMS adhesive tape. At room temperature, both sides of the EMS tape 50 are tack-free and are partially hardened. The EMS tape 50 may be used to replace conventional prepreg in the manufacturing process of hard board PCBs and is suited for thermo-pressing multi-layer laminate PCB. The advantages at least include lightweight, thin thickness, and electromagnetic shielding.

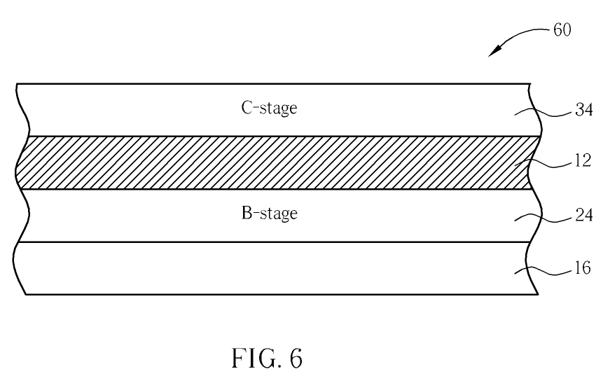

FIG. 6 is a sectional view of the laminated, two-sided EMS tape 60 prepared according to the sixth preferred embodiment of the present invention. As shown in FIG. 6, the laminated EMS tape 60 comprises a conductive backing film 12 such as aluminum foil. B-stage thermosetting resin coating 24 is coated on one side of the conductive backing film 12. C-stage thermosetting resin coating 34 is coated on the other side of the conductive backing film 12. A release layer 16 is disposed on the B-stage thermosetting resin coating 24. The EMS tape 60 is a single side thermo-pressing adhesive EMS tape. The C-stage thermosetting resin coating 34 is flexible and acts as an insulating protection film of the conductive backing film 12. On the other side of the conductive backing film 12, the B-stage thermosetting resin coating 24 is tack-free at room temperature and is partially hardened. The EMS tape 60 can be used to replace conventional coverlay in the manufacturing process of flexible PCBs. The EMS tape 60 can laminated on the flexible PCB and adhered to it using thermo-pressing methods. The EMS tape 60 has EMI function and is cheap. Advantageously, the flexible EMS tape 60 does not cause warpage of the flexible PCBs.

The thermosetting resin coatings 14, 24 and 34 at different stages may be coated on one side or two sides of the conductive backing film 12, thus generating a variety of composite film products and combinations, which are suited for EMI shielding, thermal conduction, or anti-static electricity applications, and meet different requirements of different situations.

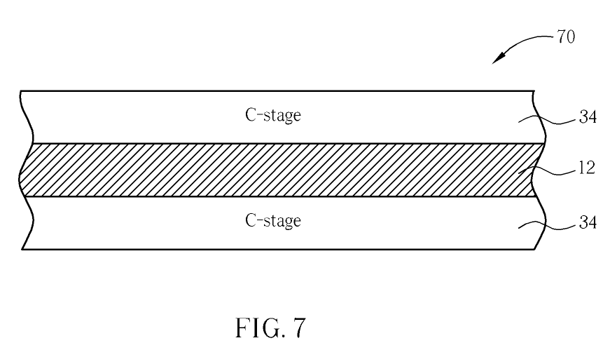

FIG. 7 is a sectional view of the laminated, two-sided EMS tape or substrate 70 prepared according to the seventh preferred embodiment of the present invention. As shown in FIG. 7, the laminated EMS substrate 70 comprises a conductive backing film 12 such as aluminum foil. C-stage thermosetting resin coating 34 is coated on both sides of the conductive backing film 12. Such EMS substrate 70 is particularly suited for flexible display devices. It is known that current displays are fairly rigid and more susceptible to breaking, while flexible displays are lighter and durable, which increases their mobility and life span. Currently, making such flexible display products is still too expensive. The EMS substrate 70 as a substrate of flexible display devices is inexpensive and can overcome the prior art shortcomings such as static electricity problem. Further, the EMS substrate 70 has advantages such as high moisture and gas resistance, chemical resistance, thermal resistance and high dimensional stability.

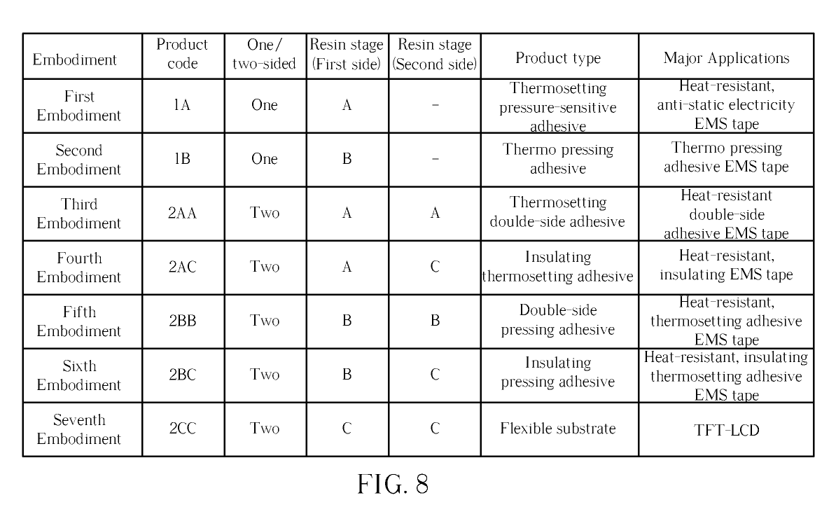

FIG. 8 lists the possible products corresponding to the embodiments described herein and applications thereof. In the second column from the left, the product code: 1A means one-sided A-stage resin coated EMS tape as set forth in FIG. 1, the product code: 1B means one-sided B-stage resin coated EMS tape as set forth in FIG. 2, the product code 2AA means two-sided A-stage resin coated EMS tape as set forth in FIG. 3, and so on.

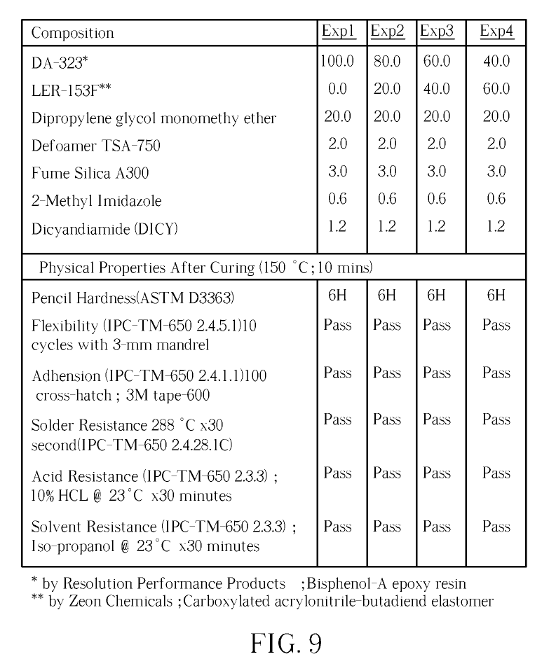

FIG. 9 lists the experiment results (Exp. 1˜Exp. 4) based on dimmer acid modified epoxy resin having different compositions. As previously mentioned, the flexible thermosetting resin coating is preferably formed of modified carboxylated NBR (modified XNBR), dimer acid-modified thermosetting epoxy resins or heat-resistive acrylic resins, and more preferably, dimer acid modified thermosetting epoxy resins.

In order to adjust the reactivity and/or physical properties, the dimer acid modified thermosetting epoxy resin may be employed singly or combined with other types of additive resins. For example, the additive resins may be selected from the group consisting of Bisphenol-A epoxy resins, Brominated Bisphenol-A epoxy resins, Bisphenol-F epoxy resins, long-chain Bisphenol-A epoxy resins, long-chain Bisphenol-F epoxy resins, CTBN modified epoxy resins, carboxylated acrylonitrile-butadiene rubber, and carboxylated acrylic rubber.

To obtain adequate softness, the content of the dimer acid modified thermosetting epoxy resin ranges between 40-100 phr of total weight of the resin mixture, while the additive resin ranges between 60-0 phr of total weight of the resin mixture.

The starting resin mixture system is mixed with proper amount of hardening agent and catalysts. The hardening agent includes dicyandiamide or imidazoles, preferably, combination of dicyandiamide and imidazoles. Assuming that the total weight of the prepared starting resin mixture is 100 phr, the content of dicyandiamide preferably ranges between 0-15.0 phr and the content of imidazole preferably ranges between 0.1-10.0 phr. According to this invention, the aforesaid catalyst may be amines, imidazoles, or BF3-MEA ranging between 0.1-10.0 phr. Other types of hardening agents such as Diamino diphenyl sulfone (DDS) and BF₃-MEA may be employed, wherein the content of DDS preferably ranges between 3-30 phr and the content of BF₃-MEA preferably ranges between 0-5.0 phr.

Other additives such as rheological agents, thixotropic reagent, fumed silica, defoamers, leveling agents, organic solvents, pigments, fire retardants and inorganic fillers may be added.

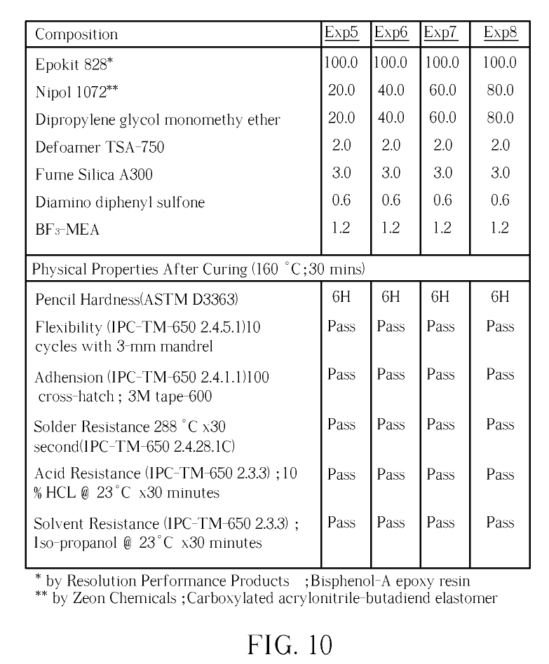

FIG. 10 lists the experiment results (Exp. 5˜Exp. 8) based on modified carboxylated NBR having different compositions.

The modified carboxylated NBR mixed with proper amount of epoxy resin is employed to form a flexible thermosetting resin system, which is suited for applications as a bonding agent between a flexible PCB and its protection film or coverlay. The flexible thermosetting resin system is typically based on a general type epoxy resin such as Bisphenol-A epoxy resins, Brominated Bisphenol-A epoxy resins, Bisphenol-F epoxy resins, long-chain Bisphenol-A epoxy resins, long-chain Bisphenol-F epoxy resins. In order to increase the softness of the thermosetting resin coating, a larger amount of modified carboxylated NBR is added. Assuming that the total weight of the prepared starting epoxy resin is 100 phr, the content of modified carboxylated NBR preferably ranges between 30-100 phr.

The hardening agent includes dicyandiamide or imidazoles, preferably, combination of dicyandiamide and imidazoles. Assuming that the total weight of the prepared starting resin mixture is 100 phr, the content of dicyandiamide preferably ranges between 0-15.0 phr and the content of imidazole preferably ranges between 0.1-10.0 phr. According to this invention, the aforesaid catalyst may be amines, imidazoles, or BF3-MEA ranging between 0.1-10.0 phr. Other types of hardening agents such as Diamino diphenyl sulfone (DDS) and BF₃-MEA may be employed, wherein the content of DDS preferably ranges between 3-30 phr and the content of BF₃-MEA preferably ranges between 0-5.0 phr.

Likewise, other additives such as rheological agents, thixotropic reagent, fumed silica, defoamers, leveling agents, organic solvents, pigments, fire retardants and inorganic fillers may be added.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A substrate for flexible display devices, comprising:
a conductive backing film having a first side and a second side;
a first fully cured C-stage thermosetting resin layer coated on the first side of the conductive backing film; and
a second fully cured C-stage thermosetting resin layer coated on the second side of the conductive backing film.

2. The substrate for flexible display devices according to claim 1 wherein the conductive backing film comprises aluminum foil.

3. The substrate for flexible display devices according to claim 1 wherein the thermosetting resin layer comprises thermosetting epoxy resins.

4. The substrate for flexible display devices according to claim 1 wherein the thermosetting resin layer comprises modified carboxylated NBR, dimer acid-modified thermosetting epoxy resins and heat-resistive acrylic resins.

5. The substrate for flexible display devices according to claim 1 wherein the thermosetting resin layer comprises additive resins selected from the group consisting of Bisphenol-A epoxy resins, Brominated Bisphenol-A epoxy resins, Bisphenol-F epoxy resins, long-chain Bisphenol-A epoxy resins, long-chain Bisphenol-F epoxy resins, CTBN modified epoxy resins, carboxylated acrylonitrile-butadiene rubber, and carboxylated acrylic rubber.

6. The substrate for flexible display devices according to claim 1 wherein the thermosetting resin layer further comprises a hardening agent.

7. The substrate for flexible display devices according to claim 6 wherein the hardening agent comprises dicyandiamide, imidazoles, Diamino diphenyl sulfone (DDS) and BF₃-MEA.

8. The substrate for flexible display devices according to claim 1 wherein the thermosetting resin layer further comprises catalyst.

9. The substrate for flexible display devices according to claim 1 wherein the thermosetting resin layer further comprises at least one of the following agents: rheological agents, thixotropic reagent, fumed silica, defoamers, leveling agents, pigments, fire retardants and inorganic fillers.
